(19) United States
(12) Patent Application Publication
(10) Pub. No.: US 2015/0064531 A1
(43) Pub. Date: Mar. 5, 2015

(54) ELECTRONIC DEVICE HAVING BATTERY PACK RECEPTACLE

(71) Applicant: SAMSUNG SDI CO., LTD., Yongin-si (KR)

(72) Inventors: Jeong-Seop LEE, Suwon-si (KR); Seok-Gyun CHANG, Suwon-si (KR); Eun-Joo KWAK, Suwon-si (KR); Myung-Sook KWON, Suwon-si (KR); Hyo-Bin BANG, Suwon-si (KR)

(21) Appl. No.: 14/469,745

(22) Filed: Aug. 27, 2014

(30) Foreign Application Priority Data
Aug. 28, 2013 (KR) 10-2013-0102119

(51) Int. Cl. H01M 2/10

(52) U.S. Cl. CPC H01M 2/1033; H01M 2220/30
USPC 429/100

(57) ABSTRACT

An electronic device includes an electronic device main body, a battery pack receptacle in the electronic device main body, and at least one variable member at an inner side of the battery pack receptacle, the variable member being movable within the space of the battery pack receptacle.

### CROSS-REFERENCE TO RELATED APPLICATION

Korean Patent Application No. 10-2013-0102119, filed on Aug. 28, 2013, in the Korean Intellectual Property Office, and entitled: “Electronic Device Having Battery Pack Receptacle,” is incorporated by reference herein in its entirety.

### BACKGROUND

1. Field

Embodiments relate to an electronic device having a battery pack receptacle, and more particularly, to an electronic device having a battery pack receptacle which can exchange battery packs.

2. Description of the Related Art

As the compactness and lightweight of portable electronic devices are rapidly developed, many studies on secondary batteries used as driving power sources of the portable electronic devices have been recently conducted. Particularly, as portable wireless devices, e.g., a video camera, a cellular phone, a notebook computer, and a portable digital assistant (PDA), become light in weight and highly functionalized, the importance of secondary batteries used as driving power sources of these devices increases.

Since the secondary batteries can be repetitively charged and discharged, the secondary batteries are economical, e.g., as compared with primary batteries. In addition, the compactness and large-capacity of the secondary batteries can be implemented. Since the secondary batteries have high operating voltage and high energy density per unit weight, the secondary batteries are widely used in high-tech electronic device fields.

### SUMMARY

According to embodiments, there is provided an electronic device having an electronic device main body, a battery pack receptacle in the electronic device main body, and at least one variable member at an inner side of the battery pack receptacle, the variable member being movable within the space of the battery pack receptacle.

The variable member may include a moving portion configured to have one end fixed to an edge of the battery pack receptacle and the other end positioned in the battery pack receptacle, and a projection portion protruded downward from the other end of the moving portion.

The one end of the moving portion may be fixed by a fixing member, and the other end of the moving portion may be formed to be movable using the fixing member as an axis according to the degree of tightening of the fixing member.

The fixing member may be formed in a bolt shape.

A projection accommodating groove for accommodating the projection portion therein may be formed in the inner side of the battery pack receptacle.

The variable member may be formed at one side of the battery pack receptacle and another side contacted with the one side.

The variable member may be formed at a corner of the battery pack receptacle.

The variable member may be formed at another side except the side of the battery pack receptacle, in which a terminal connecting portion is positioned.

A groove portion may be formed at a position corresponding to a terminal portion of the battery pack in the battery pack receptacle, and the terminal connecting portion may be formed in the groove portion.

The terminal portion of the battery pack may be protruded to be inserted into the groove portion.

The variable member may be formed of a material having elasticity.

The electronic device may further include a cover portion configured to cover the battery pack receptacle.

The electronic device may further include a battery pack inside the battery pack receptacle, the battery pack having a size equal to or smaller than the battery pack receptacle.

The battery pack may be smaller than the battery pack receptacle, an empty space being defined between at least one sidewall of the battery back and a corresponding inner sidewall of the battery pack receptacle.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective, exploded view of an electronic device according to an embodiment.

FIG. 2 illustrates a perspective view of a state in which a battery pack is inserted into a battery pack receptacle of the electronic device according to an embodiment.

FIG. 3 illustrates a perspective view of a state in which a battery pack is inserted into a battery pack receptacle of the electronic device according to another embodiment.

FIG. 4A illustrates a perspective view of an electronic device in which a groove portion is formed at one side of the battery pack receptacle of the electronic device according to another embodiment.

FIG. 4B illustrates a perspective view of a state in which a projection portion of a variable member is accommodated in the groove portion of FIG. 4A.

FIG. 5 illustrates a perspective view of a state in which a battery pack is inserted into a battery pack receptacle of the electronic device according to another embodiment.

FIG. 6 illustrates a perspective view showing a state in which a battery pack is inserted into a battery pack receptacle according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements or “on” an element, it can be the only element between the two elements or on the element, or one or more intervening elements may also be present. Like reference numerals refer to like elements throughout.

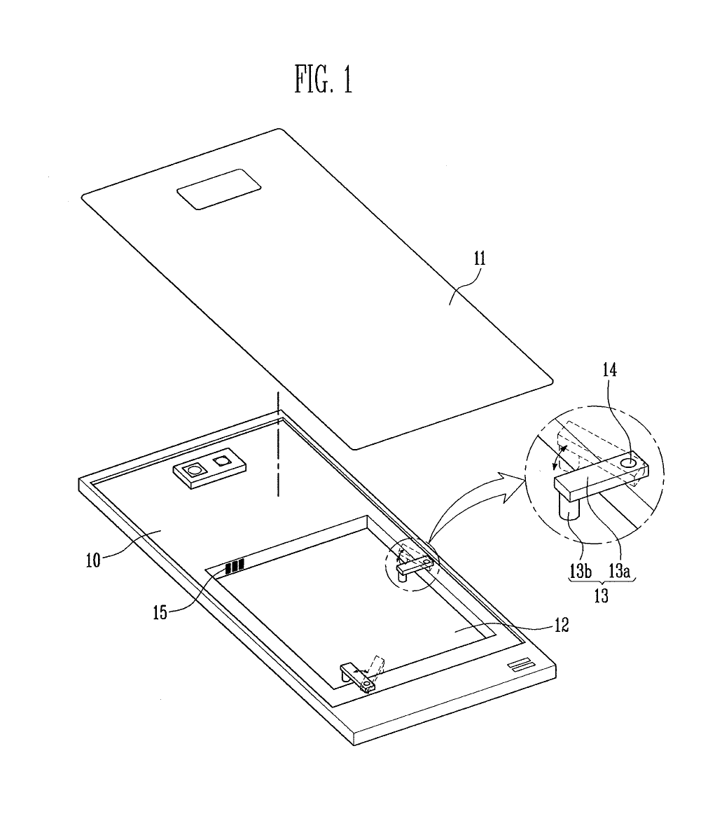

FIG. 1 illustrates a perspective view of an electronic device according to an embodiment.

Referring to FIG. 1, an electronic device according to this embodiment may include an electronic device main body 10 and a battery pack receptacle 12 provided in one area of the electronic device main body 10. The electronic device may further include a cover portion 11 configured to cover the battery pack receptacle 12. In this case, at least one variable member 13 is formed on an inner surface of the battery pack receptacle 12 so that a space of the battery pack receptacle 12 is variable.

As illustrated in FIG. 1, the variable member 13 includes a moving portion 13a and a projection portion 13b. A first end of the moving portion 13a is fixed to an edge of the battery pack receptacle 12, and a second end of the moving portion 13a is positioned in, e.g., above, the battery pack receptacle 12. The projection portion 13b protrudes downward from the second end of the moving portion 13a into the battery pack receptacle 12.

Here, the first end of the moving portion 13a of the variable member 13 is fixed to the edge of the battery pack receptacle 12 by a fixing member 14. The fixing member 14 is formed in a bolt shape, so that the second end of the moving portion 13a can be moved using the fixing member 14 as an axis according to a degree of tightening of the fixing member 14.

The variable member 13 is formed at a side of the battery pack receptacle 12 other than a side including a terminal connecting portion 15. In other words, the variable member 13 and the terminal connecting portion 15 are at different sides of the battery pack receptacle 12. For example, the electronic device may include a plurality of variable members 13. For example, as illustrated in FIG. 1, a first variable member 13 may be formed at a first side of the battery pack receptacle 12, a second variable member 13 may be formed at a second side of the battery pack receptacle 12 adjacent, e.g., perpendicular, to the first side of the battery pack receptacle 12, and the terminal connecting portion 15 may be formed at a third side of the battery pack receptacle 12 perpendicular to the first side of the battery pack receptacle 12, i.e., opposite to the second side of the battery pack receptacle 12.

Accordingly, the variable member 13 can fix a battery pack to be stationary, i.e., not to be moved, when the battery pack is mounted in the battery pack receptacle 12. For example, when the first and second variable members 13 are positioned in the battery pack receptacle 12, a battery pack smaller than the battery pack receptacle 12 may be positioned in the battery pack receptacle 12 and supported securely by the projection portions 13b of the first and second variable members 13 against respective opposite sides of the battery pack receptacle 12.

As such, the space utilization of the battery pack receptacle 12 may be varied by the variable member 13 formed on the battery pack receptacle 12 according to a size of a battery pack mounted in the battery pack receptacle 12. Accordingly, a battery pack with various sizes may be accommodated in the same battery pack receptacle 12 of the electronic device main body 10.

For example, the electronic device main body 10 may be a cellular phone (hereinafter, the cellular phone is used as the electronic device), and the battery pack may be used as a power source of the cellular phone. For example, when an application, e.g., Internet or a moving picture, with a large power consumption of a battery pack is implemented in the electronic device main body 10, e.g., in a smart phone, the capacity of the battery pack is decreased, thereby requiring frequent replacement thereof.

Accordingly, an existing battery pack having a battery pack receptacle with a space and size different from those of the battery pack receptacle 12 of the cellular phone according to this embodiment may be mounted in the battery pack receptacle 12, so that the power of the battery pack can be supplied to the cellular phone. That is, as the existing battery pack can be continuously used, it is possible to reduce cost spent in purchasing a new battery pack.

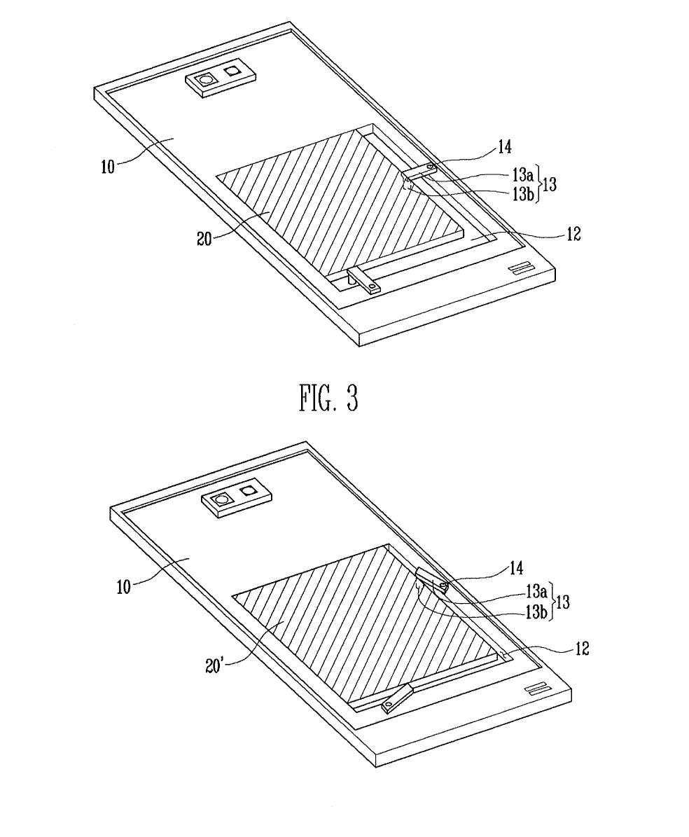

FIG. 2 illustrates a perspective view of a battery pack inside the battery pack receptacle 12 of the electronic device 10 according to a first embodiment.

Referring to FIG. 2, the battery pack receptacle 12 having a battery pack 20 mounted therein is provided at a rear side of the electronic device 10, e.g., a cellular phone 10. The variable member 13 for varying the space of the battery pack receptacle 12 is formed at an inner side of the battery pack receptacle 12. The variable member 13 includes the moving portion 13a and the projection portion 13b. The first end of the moving portion 13a is fixed at the edge of the battery pack receptacle 12, and the second end of the moving portion 13a is positioned in the battery pack receptacle 12. The projection portion 13b protrudes downward from the second end of the moving portion 13a.

The first end of the moving portion 13a, i.e., the end fixed to the edge of the battery pack receptacle 12, is fixed by the bolt-shaped fixing member 14, and accordingly, the second end of the moving portion 13a can be moved using the fixing member 14 as an axis according to the degree of tightening of the fixing member 14. In this embodiment, the battery pack 20 is formed to have a size smaller than that of the battery pack receptacle 12.

The battery pack 20 is positioned in the battery pack receptacle 12 so that a terminal portion (not shown) of the battery pack 20 corresponds, e.g., connects, to the terminal connecting portion 15 (see FIG. 1) of the battery pack receptacle 12. The variable members 13 are formed at the first and second sides of the battery pack receptacle 12, i.e., sides other than the third side that includes the terminal connecting portion 15. That is, the variable member 13 is formed at the first side, e.g., a longitudinal side, of the battery pack receptacle 12 and at the second side, e.g., a lateral side, of the battery pack receptacle 12 contacting the first side. As such, the variable member 13 supports and fixes the battery pack 20 within the battery pack receptacle 12 along lateral and longitudinal directions of the battery pack 20 which has a smaller size, e.g., smaller lateral and longitudinal dimensions, than that of the battery pack receptacle 12. Accordingly, although the battery pack 20 is formed to have a size smaller than that of the battery pack receptacle 12, the battery pack 20 can be easily fixed within the battery pack receptacle 12.

Here, the battery pack 20 mounted in the battery pack receptacle 12 has the smallest size with which the battery pack 20 can be accommodated in the battery pack receptacle 12. In this case, the moving portions 13a of the first and second variable members 13 are positioned vertically, e.g., perpendicularly, with respect to the respective first and second sides of the battery pack receptacle 12 at which the variable members 13 are formed. The projection portions 13b of the variable members 13 fix the battery pack 20 so that the battery pack 20 is stationary, i.e., not moved, while contacting, e.g., being pushed against, inner sidewalls of the battery pack receptacle 12. In this case, the variable member 13 may be formed of a material exhibiting elasticity, e.g., rubber having elasticity. Accordingly, the variable member 13 can act as a buffering member when an impact is applied to the battery pack 20.

According to embodiments, as the variable member 13 is formed at the inner side of the battery pack receptacle 12 of the cellular phone 10, e.g., as the projection portion 13b extends inside an inner space defined by the battery pack receptacle 12, the space within the battery pack receptacle 12 can be varied with various sizes, thereby allowing exchanging battery packs with various sizes. In this embodiment, the size of the battery pack 20 which can be accommodated in the battery pack receptacle 12 is not limited, and it will be apparent that the battery pack 20 with a smaller size can be accommodated in the battery pack receptacle 12 as the length of the moving portion 13a of the variable member 13 is changed.

FIG. 3 illustrates a perspective view of a battery pack 2 in the battery pack receptacle 12 of the electronic device 10 according to a second embodiment. In FIG. 3, descriptions of components identical to those of FIG. 2 will be omitted.

Referring to FIG. 3, a battery pack 20′ is inserted into the battery pack receptacle 12 of the cellular phone 10. The battery pack 20′ is larger than the battery pack 20 of FIG. 2 but smaller than the battery pack receptacle 12. Therefore, the size of the battery pack 20′ leaves a smaller empty space in the battery pack receptacle 12 than the battery pack 20 of FIG. 2.

As illustrated in FIG. 3, the variable member 13 is adjacent to the inner side of the battery pack receptacle 12. That is, the moving portion 13a of the variable member 13 is positioned toward the direction maximally parallel to the side of the battery pack 20′ adjacent thereto. For example, the moving portion 13a of the variable member 13 is inclined toward the first side of the battery pack receptacle 12, i.e., the moving portion 13a is at an oblique angle with respect to the first side of the battery pack receptacle 12, so the projection portion 13b of the variable member 13 directly contacts both the battery pack 20′ and the inner side of the battery pack receptacle 12.

The variable member 13 may be formed at two sides of the battery pack receptacle 12, except the side at which the terminal connecting portion 15 (see FIG. 1) of the battery pack receptacle 12 is positioned. That is, the variable member 13 may be formed at the first side of the battery pack receptacle 12 and at the second side contacting the first side. As such, the variable member 13 supports and fixes the battery pack 20′ in lateral and longitudinal directions of the battery pack 20′ formed with a size different from that of the battery pack receptacle 12.

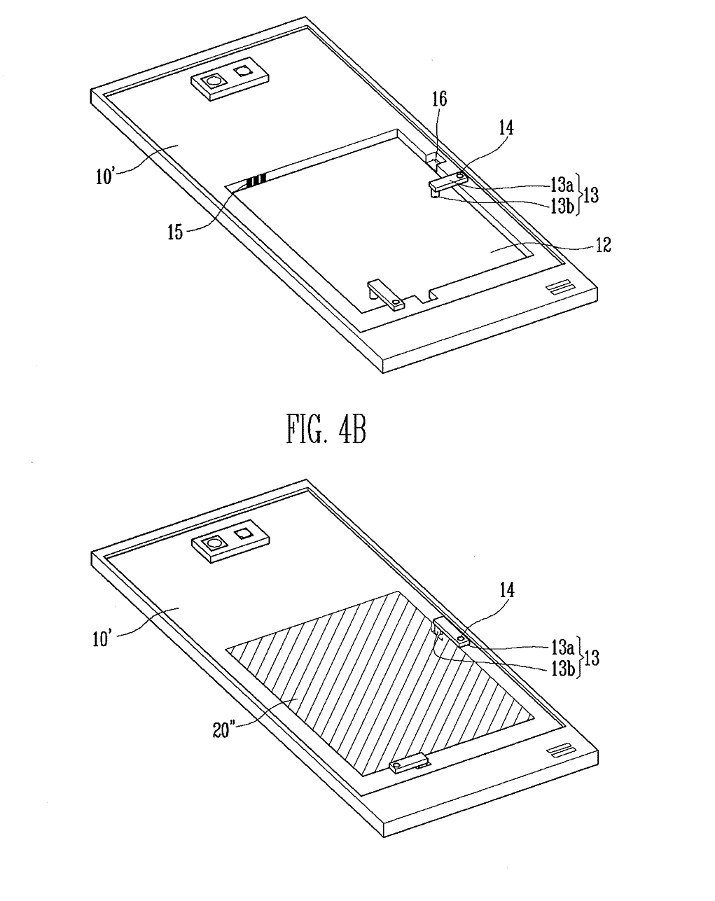

FIG. 4A illustrates a perspective view of an electronic device according to a third embodiment. FIG. 4B illustrates a perspective of a battery pack in the electronic device of FIG. 4A.

Referring to FIGS. 4A and 4B, an electronic device 10′ may be substantially the same as the electronic device 10 of FIGS. 1-3, with the exception of including a projection accommodating groove 16 at one side of the battery pack receptacle 12. As such, the variable member 13 may bent to be inserted into the projection accommodating groove 16.

In detail, as discussed previously, the variable member 13 according to this embodiment may be formed at one side of the battery pack receptacle 12 and another side contacted with the one side. Accordingly, the variable member 13 supports and fixes the battery pack 20 or battery pack 20′ formed with a size different from that of the battery pack receptacle 12 in lateral and longitudinal directions of the battery pack 20.

As illustrated in FIGS. 4A-4B, when a battery pack 20″ has a size identical to that of the space of the battery pack receptacle 12, the projection accommodating groove 16 at the first side of the battery pack receptacle 12, i.e., at a same side at which the variable member 13 is formed, may accommodate the variable member 13. That is, the projection accommodating groove 16 is formed in the inner side of the battery pack receptacle 12 to accommodate the projection portion 13b of the variable member 13 therein.

In detail, if the battery pack 20″ with a size identical to that of the battery pack receptacle 12 is mounted in the battery pack receptacle 12, the moving portion 13a of the variable member 13 is moved in the direction parallel to a side of the battery pack 20 adjacent thereto. In this case, the moving portion 13a is, e.g., completely, removed from the space of the battery pack receptacle 12 to overlap only an outer edge of the battery pack receptacle 12, and the projection portion 13b of the variable member 13 is accommodated in the projection accommodating groove 16 formed in the inner side of the battery pack receptacle 12 corresponding thereto. Accordingly, the battery pack 20″ with a size identical to that of the battery pack receptacle 12 can be accommodated in the battery pack receptacle 12 without any interference with the variable member 13.

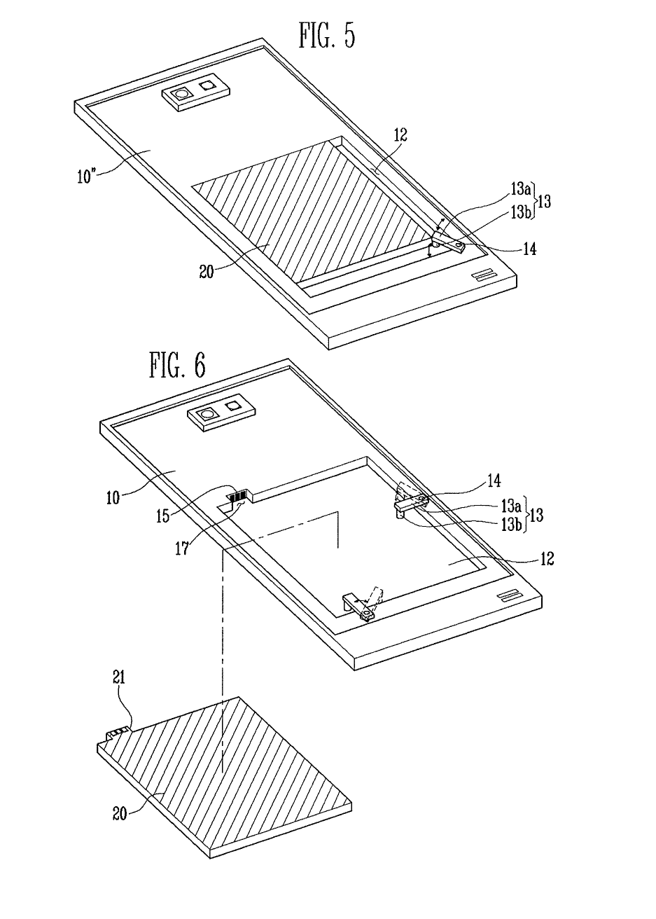

FIG. 5 illustrates a perspective view of a battery pack in the battery pack receptacle 12 of an electronic device 10″ according to a fourth embodiment.

Referring to FIG. 5, in this embodiment, the variable member 13 is formed at a corner of the battery pack receptacle 12. Here, the corner of the battery pack receptacle 12, at which the variable member 13 is formed, may be an area positioned in an approximately diagonal direction with the battery pack receptacle 12 having the terminal connecting portion 15 formed therein. Accordingly, when the battery pack 20 (or battery pack 20′) with a size smaller than that of the battery pack receptacle 12 is accommodated in the battery pack receptacle 12, the variable member 13 can fix the battery pack 20 while simultaneously supporting lateral and longitudinal directions of the battery pack 20. That is, as one variable member 13 is formed at the corner of the battery pack receptacle 12, it is possible to simultaneously support and fix the battery pack 20 in the lateral and longitudinal directions of the battery pack 20 with a simpler structure.

Although not shown in FIG. 5, like the third embodiment, a projection accommodating groove for accommodating the projection portion 13b of the variable member 13 may be formed at an inner side of the battery pack receptacle 12. Accordingly, the variable member 13 can support and fix a battery pack in the lateral and longitudinal direction of the battery pack whether the battery pack has a same size or a different size than that of the battery pack receptacle 12.

FIG. 6 illustrates a perspective view of a battery pack in a battery pack receptacle according to a fifth embodiment.

Referring to FIG. 6, variable members 13 are respectively formed at one side of the battery pack receptacle 12 and another side contacted with the one side. Accordingly, although the battery pack 20 with a size different from that of the battery pack receptacle 12 is inserted into the battery pack receptacle 12, the battery pack 20 can be supported by the variable member 13 in lateral and longitudinal directions of the battery pack 20.

A groove portion 17 is formed at a position corresponding to a terminal portion 21 of the battery pack 20 in the battery pack receptacle 12. The terminal connecting portion 15 is formed inside the groove portion 17. The terminal portion 21 of the battery pack 20 may protrude to be inserted into the groove portion 17. Accordingly, when the battery pack 20 is accommodated in the battery pack receptacle 12, the battery pack 20 can be fixed by the variable member 13. Simultaneously, the battery pack 20 can be fixed by the coupling between the groove portion 17 of the battery pack receptacle 12 and the protruded terminal portion 21 of the battery pack 20.

That is, the battery pack 20 is fixed by the variable member 13, and the terminal portion 21 of the battery pack 20 is inserted into the terminal connecting portion 15 formed in the groove portion 17, thereby exchanging the battery pack 20 with a size different from that of the space of the battery pack receptacle 12.

According to embodiments, at least one variable member is formed in the battery pack receptacle of the electronic device, so that the space of the battery pack receptacle can be varied with various sizes, thereby accommodating battery packs with various sizes. Further, although the electronic device is replaced, the existing battery pack can be exchanged regardless of the design of the battery pack receptacle, so that it is possible to continuously use the battery pack and to reduce cost.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electronic device, comprising:
an electronic device main body;
a battery pack receptacle in the electronic device main body; and
at least one variable member at an inner side of the battery pack receptacle, the variable member being movable within the battery pack receptacle.

2. The electronic device as claimed in claim 1, wherein the variable member includes:
a moving portion configured to have a first end fixed to an edge of the battery pack receptacle and a second end positioned in the battery pack receptacle; and
a projection portion protruding downward from the second end of the moving portion.

3. The electronic device as claimed in claim 2, wherein:
the first end of the moving portion is fixed to the edge of the battery pack receptacle via a fixing member, and
the second end of the moving portion is movable around an axis defined by the fixing member, the second end of the moving portion moving according to a degree of tightening of the fixing member.

4. The electronic device as claimed in claim 3, wherein the fixing member is a bolt.

5. The electronic device as claimed in claim 2, further comprising a projection accommodating groove in the inner side of the battery pack receptacle, the projection accommodating groove being configured to accommodate the projection portion of the variable member.

6. The electronic device as claimed in claim 1, wherein the variable member includes a first variable member at a first side of the battery pack receptacle and a second variable member at a second side of the battery pack receptacle, the first and second sides of the battery pack receptacle contacting each other.

7. The electronic device as claimed in claim 1, wherein the variable member is at a corner of the battery pack receptacle.

8. The electronic device as claimed in claim 1, further comprising a terminal connecting portion in the battery pack receptacle, the terminal connecting portion and the variable member being at different sides of the battery pack receptacle.

9. The electronic device as claimed in claim 1, wherein a groove portion is formed at a position corresponding to a terminal portion of the battery pack in the battery pack receptacle, and the terminal connecting portion is formed in the groove portion.

10. The electronic device as claimed in claim 9, wherein the terminal portion of the battery pack protrudes to be inserted into the groove portion.

11. The electronic device as claimed in claim 1, wherein the variable member includes a material exhibiting elasticity.

12. The electronic device as claimed in claim 1, further comprising a cover portion covering the battery pack receptacle.

13. The electronic device as claimed in claim 1, further comprising a battery pack inside the battery pack receptacle, the battery pack having a size equal to or smaller than the battery pack receptacle.

14. The electronic device as claimed in claim 13, wherein the battery pack is smaller than the battery pack receptacle, an empty space being defined between at least one sidewall of the battery back and a corresponding inner sidewall of the battery pack receptacle.
